(19) United States
(12) Patent Application Publication
(10) Pub. No.: US 2020/0020029 A1
(43) Pub. Date: Jan. 16, 2020

(54) INFORMATION MANAGEMENT APPARATUS, INFORMATION PROCESSING APPARATUS, SYSTEM, AND METHOD OF MANAGING INFORMATION

(71) Applicant: HONDA MOTOR CO., LTD., Tokyo (JP)

(72) Inventors: Yoshihide YUZA, Wako-shi (JP); Shinya TAKAHASHI, Wako-shi (JP); Yasuaki TEZUKA, Wako-shi (JP); Shohei SUZUKI, Tokyo (JP)

(21) Appl. No.: 16/580,807

(22) Filed: Sep. 24, 2019

Related U.S. Application Data
(63) Continuation of application No. PCT/JP2017/012967, filed on Mar. 29, 2017.

(51) Int. Cl. G06Q 40/02; G07C 5/00; B60W 40/09

(52) U.S. Cl. CPC G06Q 40/025; B60W 40/09; G07C 5/008

(57) ABSTRACT

An information management apparatus comprising a reception unit for receiving information about a driving feature of a vehicle from an in-vehicle device mounted on the vehicle, a configuration unit for configuring, on the basis of the information received, evaluation information indicating safety of the driving feature, the evaluation information being associated with an identifier of the vehicle or an identifier of a driver of the vehicle, and a registration unit for registering the driver and/or the vehicle as credit information if the evaluation information associated with the identifier satisfies a criterion, the credit information recommending the driver and/or the vehicle as a superior driver and/or a superior vehicle.

### CROSS-REFERENCE TO RELATED APPLICATION

This application is a continuation of International Patent Application No. PCT/JP2017/012967 filed on Mar. 29, 2017, the entire disclosures of which is incorporated herein by reference.

### TECHNICAL FIELD

The present invention relates to an information management apparatus, an information processing apparatus, a system, and a method of managing information.

### BACKGROUND ART

PTL 1 discloses using telematics to calculate automobile insurance premiums on the basis of driving history information (driving features) about vehicles. According to PTL 1, users try to drive safely so that they are charged lower premiums.

### CITATION LIST

### Patent Literature

PTL 1: Japanese Patent Laid-Open No. 2016-119004

### SUMMARY OF INVENTION

### Technical Problem

PTL 1 does not disclose uses of the driving features other than the insurance premium calculation. An object of the present invention is to provide a novel system that allows personal credit information based on driving features to be widely used for various services.

### Solution to Problem

An aspect of the present invention is an information management apparatus comprising a reception unit for receiving information about a driving feature of a vehicle from an in-vehicle device mounted on the vehicle, a configuration unit for configuring, on the basis of the information received, evaluation information indicating safety of the driving feature, the evaluation information being associated with an identifier of the vehicle, a registration unit for registering the vehicle as credit information if the evaluation information associated with the identifier satisfies a criterion, the credit information recommending the vehicle as a superior vehicle, a transmission unit for transmitting the registered credit information to another user differing from the vehicle, so as to become available for the other user, and a selection unit for selecting, on the basis of the credit information, the superior vehicle running within a predetermined distance from a current location of a first vehicle, if the reception unit receives, from an in-vehicle device mounted on the first vehicle, information indicating the current location of the first vehicle and information indicating that the first vehicle uses a function in which at least some of driving operations is performed by an ECU (Electronic Control Unit), wherein the transmission unit transmits, to the first vehicle, the selected superior vehicle.

### Advantageous Effects of Invention

According to the present invention, personal credit information based on driving features can be widely used for various services.

### BRIEF DESCRIPTION OF DRAWINGS

FIG. 1 is a diagram for describing a system that manages credit information;

FIG. 2 is a diagram for describing an exemplary vehicle configuration;

FIG. 3 is a diagram for describing a method of generating the credit information;

FIG. 4A and FIG. 4B are diagrams for describing an exemplary use of the credit information; and

FIG. 5 is a diagram for describing exemplary evaluation information and credit information.

### DESCRIPTION OF EMBODIMENTS

An embodiment of the present invention will be described below with reference to the accompanying drawings. The drawings are schematic views that illustrate structures or configurations of the embodiment, and components shown are not necessarily drawn to scale.

System Configuration

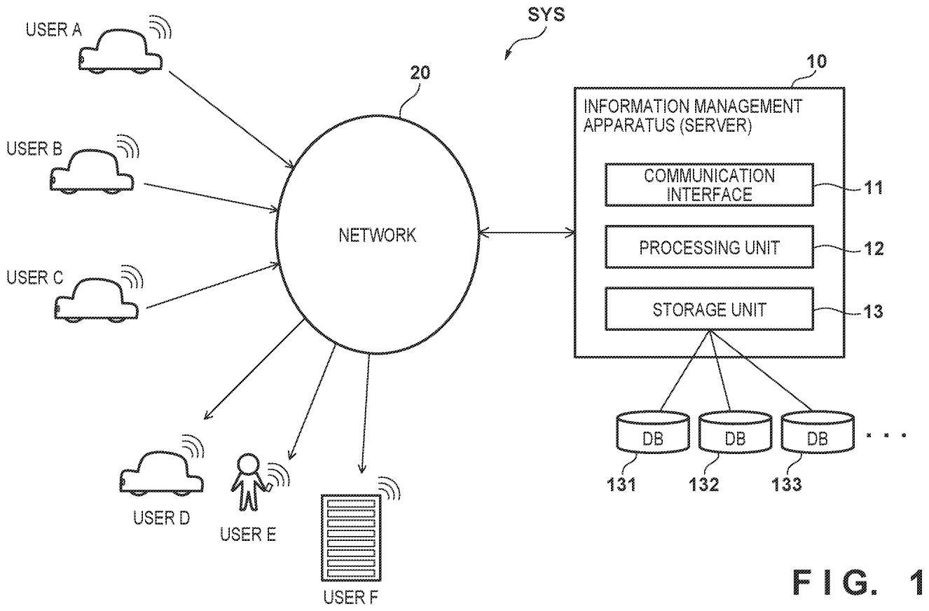

FIG. 1 illustrates the configuration of a system SYS that manages credit information. As will be described in detail below, the credit information is information indicating that a personal evaluation result based on driving features of a vehicle satisfies a predetermined criterion. The system SYS includes an information management apparatus 10 according to the embodiment, and a network 20 that realizes communication between the information management apparatus 10 and users A to F (hereinafter simply referred to “users” unless otherwise distinguished). In this embodiment, the information management apparatus 10 is a server that includes a communication interface 11, a processing unit 12, and a storage unit 13. Via the communication interface 11, the information management apparatus 10 can communicate with each user over the network 20.

The processing unit 12 includes a CPU (Central Processing Unit) and memory (RAM or ROM) and manages the credit information based on predetermined programs. While the processing unit 12 will mainly perform functions described herein, the following discussion may describe, for ease of illustration, the information management apparatus 10 as performing these functions.

The storage unit 13 is a hard disk drive, for example. In this embodiment, the storage unit 13 stores the credit information on a user basis in databases 131 to 133 (hereinafter simply referred to as “databases” unless otherwise distinguished) corresponding to the respective users A to C. As will be described in detail below, the processing unit 12 configures the credit information and its associated information to store these pieces of information in the databases, or reconfigures these pieces of information to update the databases. While the three databases 131 to 133 corresponding to the three users A to C are shown here, the numbers of users and databases are not limited to those in this example.

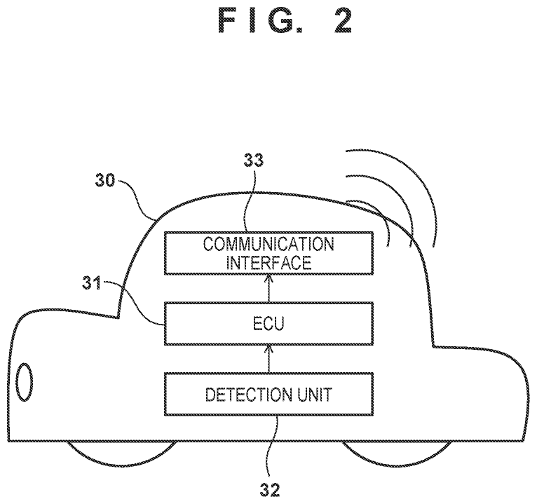

FIG. 2 is a block diagram for describing a vehicle 30 used by each of the users A to D, and in-vehicle devices therein. While the vehicle 30 is shown as a four-wheel vehicle, the vehicle 30 may be of other types such as a two-wheel vehicle. The vehicle 30 includes an ECU (Electronic Control Unit) 31, a detection unit 32, and a communication interface 33. On the basis of the result of detection by the detection unit 32, the ECU 31 transmits, via the communication interface 33, information about driving features of the vehicle (hereinafter referred to as “driving feature information”) to the information management apparatus 10 over the network 20. Connection to the network 20 may be made with various techniques, such as connection via a TCU (Telematics Communication Unit) and Wi-Fi connection. The driving feature information may be the direct result of detection by the detection unit 32 or may be information obtained based on the detection result, for example scores, ranks, or evaluation parameter values.

The detection unit 32 includes various types of sensors for detecting information associated with the driving of the vehicle 30, for example the driving state of the vehicle 30, the driving environment around the vehicle 30, and the driver's state. By way of example, the detection unit 32 includes an odometer, a speedometer, an accelerometer, a steering angle sensor, a GPS (Global Positioning System), a camera (e.g., an image sensor), and a radar (e.g., a millimeter-wave radar).

The driving state of the vehicle 30 is information indicating the state of the running vehicle 30 itself, and this information is a direct index for evaluating the driving features of the vehicle 30. Examples of the driving state of the vehicle 30 include the mileage, the vehicle speed, the amounts of changes in vehicle speed (acceleration and deceleration), the frequency of changes in vehicle speed (e.g., the frequency of hard acceleration or the frequency of hard braking), the steering angle, the amounts of changes in steering angle (the degrees of cornering), the frequency of changes in steering angle (e.g., the frequency of hard cornering). These are obtained by sensors such as a speedometer, an accelerometer, and a steering angle sensor. As another example of the driving state of the vehicle 30, centrifugal force (G) applied to the vehicle 30 is obtained, for example with a G-sensor or on the basis of the vehicle speed or the steering angle.

The driving environment around the vehicle 30 is information indicating the state of the surroundings (outside) of the running vehicle 30. This information is an index for evaluating, for example, whether the driver is not driving in a manner that could make other drivers or pedestrians feel discomfort or danger. Examples of the driving environment around the vehicle 30 include the location where the vehicle is running, which is obtained by a device such as a GPS. Other examples of the driving environment around the vehicle 30 include the speed limit and the traffic conditions (the degree of congestion) at the location where the vehicle is running, the distance from the vehicle running in front of the vehicle 30, and the presence or absence of obstacles. These are obtained by a camera and a radar, for example.

The driver's state is information indicating the state of the driver of the vehicle 30, and this information is an index for evaluating, for example, whether the driver is concentrating on the driving, or whether the driver is not driving in a bad physical condition. Examples of the driver's state include the driver's facial expression and line of sight, which are obtained by a camera, for example. As another example of the driver's state, a sensor fixable on the driver's arm may be used to obtain the value of a parameter that directly indicates the driver's physical condition, such as the heart rate or the sweat rate. As a further example of the driver's state, a sensor such as a camera may be used to detect the driver's attitude during driving, such as whether the driver is eating and/or drinking, or smoking, while driving.

The above description of the driving state of the vehicle 30, the driving environment around the vehicle 30, and the driver's state is exemplary; what may be detected by the detection unit 32 are not limited to the above examples.

Returning to FIG. 1, the information management apparatus 10 receives, via the communication interface 11, the driving feature information resulting from the detection by the detection unit 32 from the vehicle 30 of each of the users A to C over the network 20. The information management apparatus 10 causes the processing unit 12 to evaluate each user's driving features on the basis of the driving feature information and to configure evaluation information. The evaluation information is stored in the corresponding database in the storage unit 13 to be distinguishable from the evaluation information about the other users. For example, the information management apparatus 10 receives the driving feature information from the user A's vehicle 30, configures the evaluation information about the user A on the basis of the received driving feature information, and stores the evaluation information in the database 131. If the information management apparatus 10 subsequently receives the latest driving feature information, the evaluation information is reconfigured and the database is updated. The evaluation information associated with the latest driving feature information may be added to the previous evaluation information (i.e., may be accumulated), or may partially/entirely replace the previous evaluation information (i.e., the previous evaluation information may be overwritten).

The evaluation information is identified with an identifier (ID), so that the evaluation information can be associated with the corresponding user (driver) and/or the user's vehicle. In this embodiment, the driving feature information is provided from the vehicle 30 via its communication interface 33 to the information management apparatus 10 over the network 20. Therefore, the identifier-based association of the evaluation information may be based on registration information about the detection unit 32 (the serial number), or registration information about the vehicle 30 (the vehicle number). There may be cases in which the driver drives the vehicle 30 borrowed from someone such as the driver's friend. As such, the association of the evaluation information may be based on identifying the driver using an article that can identify the driver, for example an IC-embedded driver's license or an ETC (Electronic Toll Collection) card, or using a sensor such as an in-vehicle camera.

As will be described in detail below, if the evaluation information satisfies a criterion for, e.g., a certain degree of safety, the processing unit 12 generates credit information about an object that can be associated with the evaluation information. The object is typically the user (driver), but may be the vehicle 30 owned by the user. For example, the user associated by the identifier with the evaluation information may be qualified as a superior driver (safe driver), and/or the user's vehicle may be qualified as a superior vehicle (safely driven vehicle). The credit information generated as above is registered by the processing unit 12 in the database for each user in the storage unit 13.

The information management apparatus 10 can transmit the registered credit information to the other users D to F. In this embodiment, the users D, E, and F are assumed to be a driver of a vehicle 30, an individual, and a company, respectively. As will be described in detail below, the users D to F can use the received credit information in predetermined services.

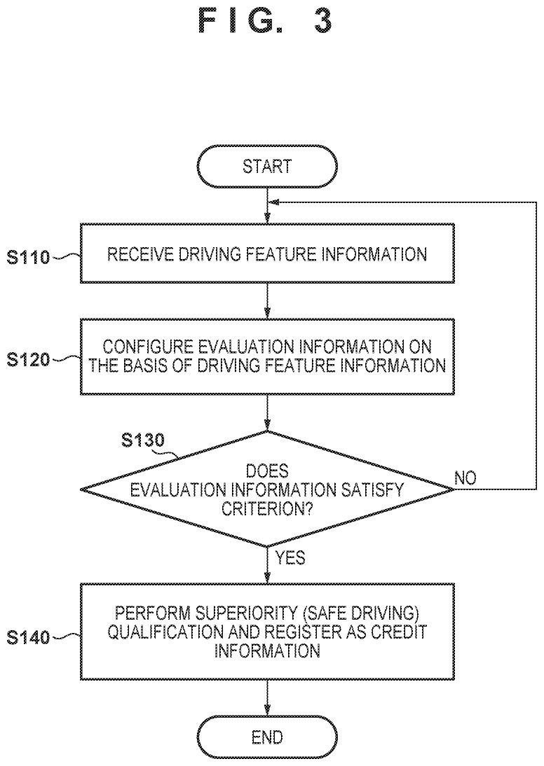

FIG. 3 is a flowchart for describing a method of generating the credit information by the information management apparatus 10. In step S110 (hereinafter simply denoted as “S110,” which also applies to the other steps), driving feature information about a vehicle 30 is received from a user, or more exactly, from an in-vehicle device mounted on the user's vehicle 30. As described above, the driving feature information may be the direct result of detection by the detection unit 32 or may be information based on the detection result. S110 may be performed at all times (continuously) while the user is driving, or periodically (e.g., hourly). Alternatively, S110 may be performed on the occurrence of a predetermined event, such as the start of driving (when the ignition system is turned on) or the termination of driving (when the ignition system is turned off).

In S120, on the basis of the driving feature information received in S110, the user's driving features are evaluated to configure evaluation information. If the user is a new user, a database corresponding to the user is created in the storage unit 13, so that the configured evaluation information is stored in that database. Otherwise, the database corresponding to the user is updated with the configured evaluation information. S120 may be performed upon the reception of the driving feature information in S110, or may be performed periodically (e.g. hourly) using the driving feature information received in S110 and accumulated (held) in the storage unit 13.

The driving features can be evaluated by determining the quality of the driving features according to a certain safety criterion, for example by performing predetermined computations based on the driving feature information or by referring to a predetermined reference table. In this embodiment, the driving features are evaluated in a point-addition scoring manner, so that the evaluation information is evaluation scores (points). For example, if the user performs no hard-acceleration or hard-braking operations during a predetermined period (e.g., one hour) or if the number of such operations is below an acceptable limit, the evaluation score earns “+1 (addition of one point).” Also, for example, if the user can maintain a normal state (e.g., concentrate on the driving without being irritated) while driving an area regarded as being congested, the evaluation score earns “+1.” It can be said that the higher the score achieved by the user in this manner, the better the user's driving features.

In this embodiment, the evaluation employs a point-addition scoring manner, thereby preventing those who seldom drive or have not driven for a long time from being provided with high scores. This increases the reliability of the evaluation information. Evaluation score points provided as the evaluation information are preferably reset or discarded after a lapse of a predetermined period (e.g., one month or one year) from the time the points were provided. That is, it is preferred that, of the added or accumulated evaluation score points, points older than a reference time point not be counted. This can further increase the reliability of the evaluation information.

In S130, it is determined whether the evaluation information configured in S120 satisfies a criterion, i.e., in this embodiment, whether the evaluation scores reach a threshold. If the evaluation scores reach the threshold, the process proceeds to S140; otherwise, the process returns to S110. S130 may be performed continuously (i.e., the process may proceed to S140 whenever the evaluation scores reach the threshold) or periodically. The threshold may be set in various manners. For example, the threshold may be calculated in relation to the average of users per area, or may be set according to the user's driving characteristics that depend on the climate or season.

In S140, in response to the evaluation information satisfying the criterion, the user is qualified as a superior driver, and/or the user's vehicle is qualified as a superior vehicle, and credit information is generated. The credit information is registered in the database in the storage unit 13.

As will be described in detail below, in this embodiment, evaluation scores of respective items are provided. If the evaluation scores of some or all of the items satisfy a predetermined condition, corresponding credit information is registered. In other embodiments, the evaluation score points may not be item-based (may be evaluated as a total score). Alternatively, the evaluation information may be ranking that allows evaluation on a scale of two or more levels (such as excellent, good, fair, and poor), rather than the evaluation scores (points).

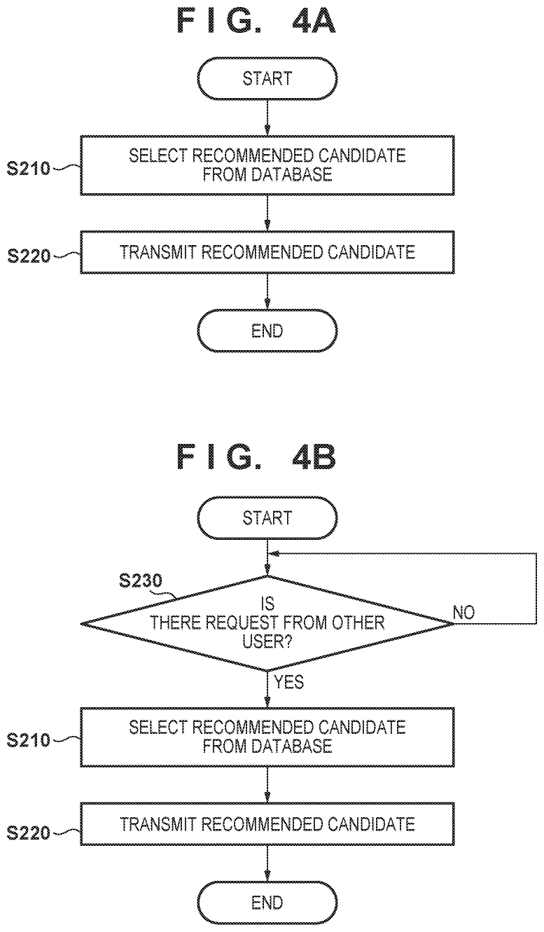

The credit information registered as above can be used by the other users D to F in predetermined services. A service refers to providing (sell, rent out, etc.) an article to a person (customer), and the article may be tangible or intangible (the article provided is often convenience, labor, etc.). As will be described in detail below, exemplary uses of services include the use of driver assistance functions (what are called automated driving functions), the use of a transportation service by vehicle, and the use of a vehicle rental service. Exemplary uses of the credit information by the information management apparatus 10 and the other users D to F will be described below with reference to flowcharts in FIGS. 4A and 4B.

### First Example

With reference to FIG. 4A, a first example will be described in which the user D (see FIG. 1) driving a vehicle 30 uses the above-described credit information. In this example, the user D uses a driver assistance function. Driver assistance refers to performing some or all of driving operations on the vehicle 30 (mainly acceleration, braking, and steering) by the ECU 31 instead of the driver. That is, in driver assistance mode, the performer of at least some of driving operations is the ECU 31 rather than the driver. Exemplary driver assistance functions include a following-distance control (adaptive cruise control (hereinafter simply referred to as “ACC”)) function, a lane-departure prevention assistance (lane keeping assist) function, and a collision avoidance assistance function.

When the user D uses the ACC function, the ECU 31 in the vehicle 30 controls the vehicle speed to maintain the distance from the vehicle running in front of the vehicle 30, while causing the detection unit 32 to measure the distance from the vehicle in front. In other words, in the use of the ACC function, the vehicle in front serves as the followed vehicle, which is followed as a benchmark for safe driving. Therefore, for the safety of the user D during the use of the ACC function, which vehicle is set as the followed vehicle is important to the user D. For ease of understanding, the following description assumes that all the users A to C are driving within a certain distance from the user D (relatively close to the user D) toward the same destination as the user D.

According to FIG. 4A, in S210, the information management apparatus 10 queries the credit information registered in the databases to select a recommended candidate for the service being used by the user D. In this example, a recommended candidate for the user D using the ACC function is selected; that is, which of the vehicles 30 driven by the users A to C is to be set as the followed vehicle is determined. In S220, the information management apparatus 10 transmits the selected recommended candidate to the user D's vehicle 30 over the network 20. The user D can accordingly select the superior vehicle as the followed vehicle.

If multiple superior vehicles are running near the user D, the information management apparatus 10 may randomly select one of the superior vehicles and transmit the result to the user D's vehicle. In this case, the information management apparatus 10 may select a vehicle using a random number, for example. This can prevent such a case that a particular superior vehicle is intensively selected as the followed vehicle by many users including the user D.

Although not described here for ease of understanding, in the process of the above flowchart, the information management apparatus 10 continuously or periodically receives information indicating the current location of the user D's vehicle from the user D's vehicle, and also receives information indicating the current locations of the vehicles of the users A to C from their vehicles. This allows the information management apparatus 10 to search the databases for any superior vehicle running within a certain distance from the user D.

The example here illustrates the case of using the ACC function. However, the above description is also applicable to other driver assistance functions because the relationships with the driving features of other surrounding vehicles are essential to the safe use of any driver assistance function.

### Second Example

With reference to FIG. 4B, a second example will be described in which the user E (see FIG. 1) uses the above-described credit information. The user E uses a transportation service with a vehicle, which is a taxi in this example. Many of taxi users are those who prefer mild driving that does not make the users feel much acceleration or centrifugal force, such as relatively aged people, injured people, and people desiring to take a nap during a ride. If the user E wants to use a taxi driven in such a mild manner, which taxi to take is important to the user E. For ease of understanding, the following description assumes that all the users A to C are drivers of taxis running within a certain distance from the user E.

According to FIG. 4B, if a request is received from the user E in S230, the process proceeds to S210; otherwise, the process returns to S230. This request is a request to query the credit information and, in this embodiment, asks for a recommended candidate taxi that meets the user E's preference. The request is made using a mobile terminal (such as a smartphone), for example. The information management apparatus 10 thus receives, from the user E, information indicating that the user E wants to use a taxi and what kind of taxi the user E prefers, as well as information indicating the user E's current location.

In S210, the information management apparatus 10 queries the credit information registered in the databases to select a recommended candidate for the service being used by the user E. In this example, a recommended candidate that meets the user E's preference is selected; that is, which of the vehicles 30 driven by the users A to C should be taken by the user E is determined. Subsequently, in S220, the information management apparatus 10 transmits the selected recommended candidate to the user E over the network 20. The user E can thus use the taxi regarded as a superior vehicle.

The two examples have been illustrated above: the first example of using the ACC function, and the second example of using a taxi. Generally, information about objects directly or indirectly related to the use of a service is considered to be of high interest for users of the service. Therefore, if the objects have credit information based on driving features, allowing the users of the service to utilize the credit information can make the service safe and secure. In addition, such a mechanism facilitates improvements in traffic conditions, such as prevention of accidents, because each driver is expected to be mindful of safe driving.

For ease of understanding, the above first and second examples have been described with reference to the flowcharts in FIGS. 4A and 4B, respectively. However, the flowchart in FIG. 4B is also applicable to the first example in which the user D uses the ACC function. For example, before using the ACC function, the user D can query the information management apparatus 10 whether a vehicle appropriate as the followed vehicle is running near the user D. That is, S230 described above may be performed by the information management apparatus 10 in response to the user D's continuous (or periodical) request. Alternatively, even in the absence of such a request, S230 may be performed on the basis of a setting (subscription) made in advance specifying that the apparatus 10 should continuously transmit the credit information to the vehicle 30. Thus, the information management apparatus 10 may transmit the credit information in response to a request to query the credit information from the vehicle 30 (user D) starting the use of the ACC function, or may continuously transmit the credit information to vehicles 30 having the ACC function. In either case, the information management apparatus 10 will return a query result in response to a request to query the credit information.

### Third Example

A third example will be described in which the user F (see FIG. 1) uses the above-described credit information. The user F is a service provider, which is, in this example, a service company providing a rental service of vehicles 30. In rental services, in order to allow a rental object returned from a user to be rentable to the next user, certain preparations may be required of the service provider, such as maintenance of the returned object. It is therefore important to the user F how a vehicle 30, which is a rental object, is used. For ease of understanding, the following description assumes that all the users A to C are users of the user F's service.

In this example, when renting out vehicles 30 to the users A to C, the user F can use, e.g., a terminal in the shop to make a request to query whether the credit information about the users A to C is registered in the databases 131 to 133 in the storage unit 13. That is, the user F can query for the registration of the credit information about the users A to C and predict the driving features of the users A to C on the basis of the query result. In this case, the information management apparatus 10 may return the query result to the user F (more exactly, to the terminal in the shop) according to the flowchart in FIG. 4B. Thus, for each of the vehicles 30 returned from the users A to C, the user F can determine whether the vehicle 30 requires maintenance, and if so, to what extent the maintenance should be performed, which maintenance items can be skipped, and the like. Alternatively, the information management apparatus 10 may transmit such maintenance information to the user F.

In this example, in addition to or instead of querying for the registration of the credit information about the users A to C, the user F may refer to the evaluation information (in this example, the evaluation scores) for the period from the renting out to the returning of the vehicles 30. The reason for this is as follows. For example, even if the credit information about the users A to C is not registered in the databases 131 to 133 at the time of renting out the vehicles 30, the driving features of the users A to C may be relatively good. Also, in vehicle rental services, a vehicle 30 is typically expected to be returned within a relatively short period of time (e.g., one day or one week), so that the credit information may not be registered during such a short period of time. Further, a vehicle rental service is under special conditions such that it involves criteria different from those in the first and second examples, such as whether the interior of the vehicle is kept clean during the use.

The user F may therefore refer to the evaluation scores achieved during renting the vehicles 30 to make the above maintenance-related determination. In this manner, even if the credit information about the user A, for example, is not registered in the database 131, the user F can determine to skip some of the maintenance items if the user A achieves a high evaluation score while renting the vehicle 30. Conversely, even if the credit information about the user A, for example, is registered in the database 131, the user F can determine not to skip any of the maintenance items if the user A achieves a low evaluation score while renting the vehicle 30. It is to be noted that, in this example, S110 to S120 (see FIG. 3) may be performed continuously or at relatively short intervals (e.g., every 10 minutes or hourly).

Thus, the above-described credit information can also be used by a service provider, and the evaluation information may additionally/alternatively be used. While the rental service of vehicles 30 is illustrated here, the description of the above example is also applicable to car sharing services, which may be regarded as a form of rental services.

### Specific Example of Method of Evaluation Based on Driving Feature Information

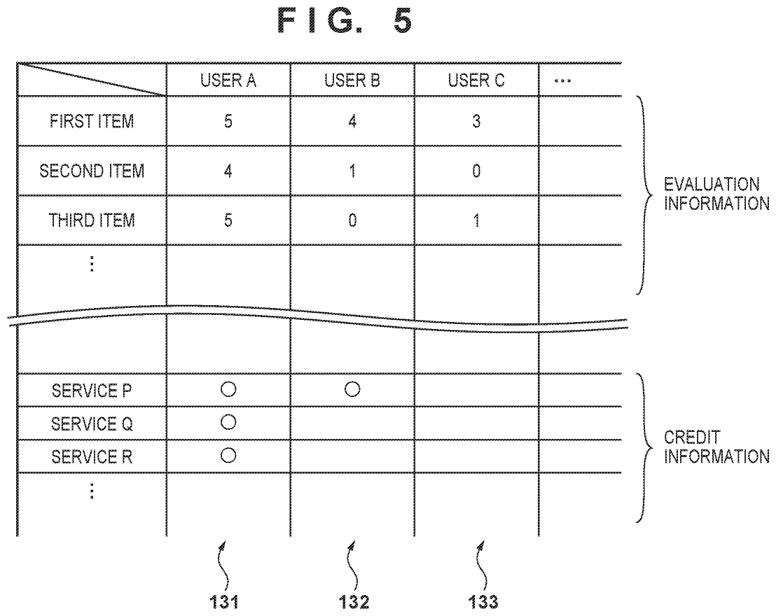

An exemplary method of evaluation based on the driving feature information about the users A to C will be described with reference to FIG. 5. As described above, the driving feature information may be the direct result of detection by the detection unit 32 or may be information based on the detection result.

Here, because the users D to F each have a different requirement (such as items and their criteria), the driving feature information is evaluated on an item basis. For example, the user D, who uses the ACC function, may particularly focus attention on safety. The user E, who uses a taxi, may focus attention on ride comfort in addition to safety. The user F, who provides the rental service, may focus on whether a rental vehicle is returned in clean condition, in addition to safety. The driving feature information is therefore evaluated on an item basis in this embodiment. If the evaluation result satisfies the condition for any service, corresponding credit information is generated. That is, two or more pieces of credit information may be generated for one user.

The first item shown in FIG. 5 indicates each driver's basic driving ability (e.g., the quickness and accuracy of assessing the situation during driving, such as few hard-acceleration and hard-braking operations). The second item indicates each driver's driving technique (e.g., whether the driver drives in a mild manner that does not make occupants feel much acceleration, centrifugal force, etc.). The third item indicates the vehicle usage condition (e.g., whether the user eats and/or drinks, or smokes, in the vehicle).

While the three items corresponding to the respective requirements of the users D to F are illustrated here for ease of understanding, each item may be further subdivided, or there may be four or more items. If further subdivided items are evaluated, various detection results obtained by the above-described detection unit 32 may be used.

For example, a service P, which provides the use of the ACC function described above (see the first example), places importance especially on the first item, less importance on the second item than the first item, and substantially no importance on the third item. For example, a service Q, which provides the use of a taxi described above (see the second example), places importance especially on the first and second items and less importance on the third item. For example, a service R, which provides the rental service described above (see the third example), places importance on all the first to third items.

Then, a weighted sum of the evaluation scores of the first to third items may be calculated with predetermined coefficients to determine whether the credit information is allowed to be generated.

For example, for the service P, this determination is made on the basis of whether the following condition is satisfied.

E₁×α_{P1}+E₂×α_{P2}+E₃×α_{P3}≥E_{TH_P} (a first condition):
E₁: the evaluation score of the first item for a user
E₂: the evaluation score of the second item for the user
E₃: the evaluation score of the third item for the user
α_{P1}: a coefficient (α_{P1}>0)
α_{P2}: a coefficient (α_{P1}>α_{P2}>0)
α_{P3}: a coefficient (α_{P3}=0)
E_{TH_P}: the threshold required by the service P

If the above first condition is satisfied, the credit information available for the service P is generated for the user and registered in the database in the storage unit 13.

Similarly, for the service Q, whether the credit information is allowed to be generated is determined on the basis whether the following condition is satisfied.

E₁×α_{Q1}+E₂×α_{Q2}+E₃×α_{Q3}≥E_{TH_Q} (a second condition):
α_{Q1}: a coefficient (α_{Q1}>0)
α_{Q2}: a coefficient (α_{Q2}=α_{Q1}>0)
α_{Q3}: a coefficient (α_{Q1} (=α_{Q2})>α_{Q3}≥0)
E_{TH_Q}: the threshold required by the service Q

In the second condition, the coefficients may be such that α_{Q1}≠α_{Q2} depending on the degrees importance, as long as both coefficients are greater than 0.

Similarly, for the service R, whether the credit information is allowed to be generated is determined on the basis whether the following condition is satisfied.

E₁×α_{R1}+E₂×α_{R2}+E₃×α_{R3}≥E_{TH_R} (a third condition):
α_{R1}: a coefficient (α_{R1}>0)
α_{R2}: a coefficient (α_{R2}=α_{R1}>0)
α_{R3}: a coefficient (α_{R3}=α_{R2}=α_{R1}>0)
E_{TH_R}: the threshold required by the service R

In the third condition, the coefficients may be such that α_{R1}≠α_{R2}≠α_{R3} depending on the degrees of importance, as long as all the coefficients are greater than 0.

According to this embodiment, the user A has relatively high evaluation scores for all the first to third items. The user B has a relatively high evaluation score for the first item among the first to third items. The user C has relatively low evaluation scores for all the first to third items. As a result, in this embodiment, the service P has the credit information about the users A and B registered therewith, and the services Q and R only has the credit information about the user A registered therewith (“∘” in FIG. 5 indicates that the credit information is registered). In terms of users, the user A has the credit information registered in the database 131 and available for the services P, Q, and R. The user B has the credit information registered in the database 132 and available for the service P. The user C has no credit information registered in the database 133.

Therefore, in the above-described first example, the user D using the ACC function may select either the user A's vehicle or the user B's vehicle as the followed vehicle on the basis of the credit information received from the information management apparatus 10. In the above-described second example, the user E using a taxi may take the user A's vehicle on the basis of the credit information received from the information management apparatus 10. In the above-described third example, the user F providing the rental service may determine to skip some of the maintenance items for the vehicle 30 returned from the user A on the basis of the credit information received from the information management apparatus 10.

Another Exemplary System Using Credit Information

The above description has illustrated the case in which the information management apparatus 10 manages both the credit information and the services. Alternatively, the system SYS may be configured such that the information management apparatus 10 manages the credit information while some other server (an information processing apparatus) manages the services. For example, the other server and the information management apparatus 10 each belong to a different company. The other server is in communication with the information management apparatus 10, and the information management apparatus 10 outputs the credit information resulting from the flowchart in FIG. 3 to the other server. The other server, having received the credit information from the information management apparatus 10, uses the credit information to provide the services illustrated in the above first to third examples, as well as other services. A system like this allows the credit information to be used for various services in a relatively simple configuration.

Variations

The information management apparatus 10 may evaluate the driving features based on the driving feature information received from a vehicle 30 and provide a notification of, e.g., driving features that should be improved, to a preregistered recipient (e.g., the vehicle 30 or its driver's mobile terminal) over the network 20. For example, if the above evaluation shows that the number of hard-acceleration and hard-braking operations in a predetermined time period exceeds an acceptable limit, the vehicle 30 or the driver's mobile terminal may be notified of that fact. This can prompt the driver to improve the driving feature, thereby facilitating improvements in traffic conditions such as prevention of accidents.

As another example, the information management apparatus 10 may notify a user of any risk of an accident to the user's vehicle 30. For example, if the evaluation information (an evaluation score) based on the driving feature information does not reach a predetermined threshold after a lapse of a certain time period from the start of the user's driving, the user may be notified of that fact. This can prompt the user to improve the driving feature, thereby facilitating improvements in traffic conditions such as prevention of accidents. In another example, if a vehicle with quite low levels of credit information and evaluation information despite long total driving hours is or might be driving near a user, the user may be notified of that fact. This can alert the user not to be involved in an accident, thereby facilitating improvements in traffic conditions such as prevention of accidents.

Thus, according to this embodiment, the personal credit information based on the driving features can be widely used for various services. The uses of the credit information are not limited to the above-described examples but may be varied according to factors such as purposes. It is also possible to combine an aspect of an example with some of the aspects of the other examples.

### Summary of Embodiment

A first aspect is an information management apparatus (e.g., 10) including: a reception unit (e.g., 11) for receiving information about a driving feature of a vehicle (e.g., the users A to C, 30) from an in-vehicle device (e.g., 31 to 33) mounted on the vehicle; a configuration unit (e.g., 12) for configuring, on the basis of the information received, evaluation information indicating safety of the driving feature, the evaluation information being associated with an identifier of the vehicle or an identifier of a driver of the vehicle; and a registration unit (e.g., 12 and 13) for registering the driver and/or the vehicle as credit information if the evaluation information associated with the identifier satisfies a criterion, the credit information recommending the driver and/or the vehicle as a superior driver and/or a superior vehicle.

According to the first aspect, the driver and/or the vehicle identifiable by the identifier is registered as a superior driver (safe driver) or a superior vehicle (safely driven vehicle) on the basis of the evaluation information about the driving characteristics of the driver and/or the vehicle. The registered information can be used as credit information for various services. Because each driver is expected to be mindful of safe driving, improvements in traffic conditions such as prevention of accidents are also possible.

In a second aspect, the configuration unit configures the evaluation information by evaluating the driving feature in a point-addition scoring manner on the basis of the information received.

According to the second aspect, because the driving feature is evaluated in a point-addition scoring manner, the evaluation is fair and precise. For example, this can prevent those who seldom drive or have not driven for a long time from being qualified as superior drivers.

In a third aspect, the apparatus further includes a transmission unit (e.g., 11) for returning a query result in response to a request to query the credit information registered.

According to the third aspect, those who want to use the credit information can appropriately query the credit information. The query result may be returned in response to every query request from those who want to use the credit information. Alternatively, the query result may be transmitted whenever the credit information is registered, if it is requested to do so.

In a fourth aspect, if the driving feature suggests unsafety, the transmission unit transmits information indicating the unsafety to a preregistered recipient.

According to the fourth aspect, if the driving feature is inadequate, the vehicle or the driver's mobile terminal (such as a smartphone), for example, is notified of that fact. This prompts the driver to improve the driving features, thereby realizing improvements in traffic conditions such as prevention of accidents.

In a fifth aspect, the registration unit registers at least the superior vehicle. The apparatus further includes a selection unit (e.g., 12) for selecting, on the basis of the credit information, the superior vehicle running within a predetermined distance from the current location of a first vehicle (e.g., the user D) if the reception unit receives, from an in-vehicle device in the first vehicle, information indicating the current location of the first vehicle and information indicating that the first vehicle uses a following-distance control (ACC) function. The transmission unit transmits, to the first vehicle, the superior vehicle selected. According to the fifth aspect, the first vehicle can select a safely driven vehicle as the followed vehicle in the ACC. This realizes improvements in traffic conditions, such as prevention of accidents.

In a sixth aspect, the registration unit registers at least the superior vehicle. The apparatus further includes a selection unit (e.g., 12) for selecting, on the basis of the credit information, the superior vehicle running within a predetermined distance from a user's (e.g., the user E's) current location if the reception unit receives, from the user's mobile terminal, information indicating the user's current location and information indicating that the user desires to use a transportation service. The transmission unit transmits, to the user's mobile terminal, the superior vehicle selected.

According to the sixth aspect, a user of a transportation service by vehicle, such as by taxi, can select a safely driven vehicle as a vehicle to take.

In a seventh aspect, if multiple superior vehicles are running within the predetermined distance, the selection unit randomly selects one of the superior vehicles.

According to the seventh aspect, if multiple superior vehicles are available, one of the superior vehicles is randomly selected. This can prevent such a case that a particular superior vehicle is intensively selected by many users.

In an eighth aspect, the registration unit registers at least the superior driver. If the reception unit receives, from a terminal in a shop (e.g., of the user F) providing a vehicle rental service, information indicating that the shop rents out a vehicle to a customer, the transmission unit transmits information indicating whether the customer is registered as the superior driver to the terminal in the shop on the basis of the credit information.

According to the eighth aspect, the credit information can be used in vehicle rental services and car sharing services, for example.

In a ninth aspect, the transmission unit transmits maintenance information about the vehicle rented out to the customer to the terminal in the shop on the basis of whether the customer is registered as the superior driver.

According to the ninth aspect, the service provider can check the maintenance information about the vehicle used by the customer (e.g., whether some of maintenance items can be skipped).

In a tenth aspect, the transmission unit transmits, to a preregistered recipient, the degree of danger to the vehicle based on the driving feature.

According to the tenth aspect, improvements in traffic conditions such as prevention of accidents are realized.

In an eleventh aspect, the driving feature includes the driving state of the vehicle, the state of the driver of the vehicle, and/or the driving environment around the vehicle.

According to the eleventh aspect, the degree of danger can be appropriately calculated. The driving state of the vehicle includes, for example, the mileage, the vehicle speed, the amounts of changes in vehicle speed and their frequency, the steering angle, and the amounts of changes in steering angle and their frequency. The driving environment around the vehicle includes, for example, the location where the vehicle is running, and the speed limit and the traffic conditions (the degree of congestion) at the location. The driver's state includes, for example, the driver's facial expression, line of sight, heart rate, and sweat rate. These may all be obtained by various in-vehicle sensors (such as a camera and a radar).

A twelfth aspect is an information processing apparatus (e.g., the user F's server) capable of communicating with the information management apparatus (e.g., 10). The information processing apparatus includes: a unit for receiving the credit information from the information management apparatus; and a unit for transmitting the credit information to a user's mobile terminal if a request to query for the superior driver or the superior vehicle is received from the user's mobile terminal.

According to the twelfth aspect, the variety of services using the credit information can be advantageously increased.

A thirteenth aspect is a system (e.g., SYS) including multiple vehicles (e.g., the users A to C, 30) and a server (e.g., 10). The server includes: a reception unit (e.g., 11) for receiving information about a driving feature of each vehicle from an in-vehicle device (e.g., 31 to 33) mounted on the vehicle; a configuration unit (e.g., 12) for configuring, on the basis of the information received, evaluation information indicating safety of the driving feature, the evaluation information being associated with an identifier of the vehicle or an identifier of a driver of the vehicle; and a registration unit (e.g., 12 and 13) for registering the driver and/or the vehicle as credit information if the evaluation information associated with the identifier satisfies a criterion, the credit information recommending the driver and/or the vehicle as a superior driver and/or a superior vehicle.

According to the thirteenth aspect, as in the first aspect, the credit information can be used for various services while traffic conditions can be improved.

A fourteenth aspect is a method of managing information, including: receiving (S110) information about a driving feature of a vehicle (e.g., the users A to C, 30) from an in-vehicle device (e.g., 31 to 33) mounted on the vehicle; configuring (S120), on the basis of the information received, evaluation information indicating safety of the driving feature, the evaluation information being associated with an identifier of the vehicle or an identifier of a driver of the vehicle; and registering (S130 and S140) the driver and/or the vehicle as credit information if the evaluation information associated with the identifier satisfies a criterion, the credit information recommending the driver and/or the vehicle as a superior driver and/or a superior vehicle.

According to the fourteenth aspect, as in the first aspect, the credit information can be used for various services while traffic conditions can be improved.

The present invention is not limited to the above embodiments and various changes and modifications can be made within the spirit and scope of the present invention. Therefore, to apprise the public of the scope of the present invention, the following claims are made.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

### REFERENCE SIGNS LIST

10: information management apparatus
11: communication interface
12: processing unit
13: storage unit
20: network

1. An information management apparatus comprising:
a reception unit for receiving information about a driving feature of a vehicle from an in-vehicle device mounted on the vehicle;
a configuration unit for configuring, on the basis of the information received, evaluation information indicating safety of the driving feature, the evaluation information being associated with an identifier of the vehicle;
a registration unit for registering the vehicle as credit information if the evaluation information associated with the identifier satisfies a criterion, the credit information recommending the vehicle as a superior vehicle;
a transmission unit for transmitting the registered credit information to another user differing from the vehicle, so as to become available for the other user; and
a selection unit for selecting, on the basis of the credit information, the superior vehicle running within a predetermined distance from a current location of a first vehicle, if the reception unit receives, from an in-vehicle device mounted on the first vehicle, information indicating the current location of the first vehicle and information indicating that the first vehicle uses a function in which at least some of driving operations is performed by an ECU (Electronic Control Unit),
wherein the transmission unit transmits, to the first vehicle, the selected superior vehicle.

2. An information management apparatus comprising:
a reception unit for receiving information about a driving feature of a vehicle from an in-vehicle device mounted on the vehicle;
a configuration unit for configuring, on the basis of the information received, evaluation information indicating safety of the driving feature, the evaluation information being associated with an identifier of the vehicle;
a registration unit for registering the vehicle as credit information if the evaluation information associated with the identifier satisfies a criterion, the credit information recommending the vehicle as a superior vehicle;
a transmission unit for transmitting the registered credit information to another user differing from the vehicle, so as to become available for the other user; and
a selection unit for selecting, on the basis of the credit information, the superior vehicle running within a predetermined distance from a user's current location, if the reception unit receives, from the user's mobile terminal, information indicating the user's current location and information indicating that the user desires to use a predetermined service with a vehicle,
wherein the transmission unit transmits, to the user's mobile terminal, the selected superior vehicle.

3. The information management apparatus according to claim 1, wherein, if the superior vehicle running within the predetermined distance comprises a plurality of superior vehicles, the selection unit randomly selects one of the plurality of superior vehicles.

4. An information management apparatus comprising:
a reception unit for receiving information about a driving feature of a vehicle from an in-vehicle device mounted on the vehicle;
a configuration unit for configuring, on the basis of the information received, evaluation information indicating safety of the driving feature, the evaluation information being associated with an identifier of a driver of the vehicle;
a registration unit for registering the driver as credit information if the evaluation information associated with the identifier satisfies a criterion, the credit information recommending the driver as a superior driver; and
a transmission unit for transmitting the registered credit information to another user differing from the driver, so as to become available for the other user,
wherein, if the reception unit receives, from a terminal in a shop providing a predetermined service with a vehicle, information indicating that the shop provides the predetermined service to a customer, the transmission unit transmits, to the terminal in the shop, information indicating whether the customer is registered as the superior driver, on the basis of the credit information.

5. The information management apparatus according to claim 4, wherein the transmission unit transmits, to the terminal in the shop, maintenance information about the vehicle used in the predetermined service for the customer, on the basis of whether the customer is registered as the superior driver.

6. The information management apparatus according to claim 1, wherein the configuration unit configures the evaluation information by evaluating the driving feature in a point-addition scoring manner on the basis of the information received.

7. The information management apparatus according to claim 1, wherein the transmission unit returns a query result in response to a request to query the registered credit information from the other user.

8. The information management apparatus according to claim 1, wherein, if the driving feature suggests unsafety, the transmission unit transmits information indicating the unsafety to a preregistered recipient.

9. The information management apparatus according to claim 1, wherein the transmission unit transmits, to a preregistered recipient, a degree of danger to the vehicle based on the driving feature.

10. The information management apparatus according to claim 9, wherein the driving feature comprises a driving state of the vehicle, a state of the driver of the vehicle, and/or a driving environment around the vehicle.

11. An information processing apparatus capable of communicating with the information management apparatus according to claim 1, comprising:
a unit for receiving the credit information from the information management apparatus; and
a unit for transmitting the credit information to a user's mobile terminal if a request to query for the credit information is received from a user's mobile terminal.

12. A system comprising a plurality of vehicles and a server, the server comprises:
a reception unit for receiving information about a driving feature of each vehicle from an in-vehicle device mounted on the vehicle;
a configuration unit for configuring, on the basis of the information received, evaluation information indicating safety of the driving feature, the evaluation information being associated with an identifier of the vehicle;
a registration unit for registering the vehicle as credit information if the evaluation information associated with the identifier satisfies a criterion, the credit information recommending the vehicle as a superior vehicle;
a transmission unit for transmitting the registered credit information to another user differing from the vehicle, so as to become available for the other user; and
a selection unit for selecting, on the basis of the credit information, the superior vehicle running within a predetermined distance from a current location of a first vehicle, if the reception unit receives, from an in-vehicle device mounted on the first vehicle, information indicating the current location of the first vehicle and information indicating that the first vehicle uses a function in which at least some of driving operations is performed by an ECU (Electronic Control Unit),
wherein the transmission unit transmits, to the first vehicle, the selected superior vehicle.

13. A system comprising a plurality of vehicles and a server, the server comprises:
a reception unit for receiving information about a driving feature of each vehicle from an in-vehicle device mounted on the vehicle;
a configuration unit for configuring, on the basis of the information received, evaluation information indicating safety of the driving feature, the evaluation information being associated with an identifier of the vehicle;
a registration unit for registering the vehicle as credit information if the evaluation information associated with the identifier satisfies a criterion, the credit information recommending the vehicle as a superior vehicle;
a transmission unit for transmitting the registered credit information to another user differing from the vehicle, so as to become available for the other user; and
a selection unit for selecting, on the basis of the credit information, the superior vehicle running within a predetermined distance from a user's current location, if the reception unit receives, from the user's mobile terminal, information indicating the user's current location and information indicating that the user desires to use a predetermined service with a vehicle,
wherein the transmission unit transmits, to the user's mobile terminal, the selected superior vehicle.

14. A system comprising a plurality of vehicles and a server, the server comprises:
a reception unit for receiving information about a driving feature of each vehicle from an in-vehicle device mounted on the vehicle;
a configuration unit for configuring, on the basis of the information received, evaluation information indicating safety of the driving feature, the evaluation information being associated with an identifier of a driver of the vehicle;
a registration unit for registering the driver as credit information if the evaluation information associated with the identifier satisfies a criterion, the credit information recommending the driver as a superior driver; and
a transmission unit for transmitting the registered credit information to another user differing from the driver, so as to become available for the other user,
wherein, if the reception unit receives, from a terminal in a shop providing a predetermined service with a vehicle, information indicating that the shop provides the predetermined service to a customer, the transmission unit transmits, to the terminal in the shop, information indicating whether the customer is registered as the superior driver, on the basis of the credit information.

15. A method of managing information, comprising:
receiving information about a driving feature of a vehicle from an in-vehicle device mounted on the vehicle;
configuring, on the basis of the information received, evaluation information indicating safety of the driving feature, the evaluation information being associated with an identifier of the vehicle;
registering the vehicle as credit information if the evaluation information associated with the identifier satisfies a criterion, the credit information recommending the vehicle as a superior vehicle;
transmitting the registered credit information to another user differing from the vehicle, so as to become available for the other user; and
selecting, on the basis of the credit information, the superior vehicle running within a predetermined distance from a current location of a first vehicle, if, in the receiving, information indicating the current location of the first vehicle and information indicating that the first vehicle uses a function in which at least some of driving operations is performed by an ECU (Electronic Control Unit) are received from an in-vehicle device mounted on the first vehicle,
wherein, in the transmitting, the selected superior vehicle is transmitted to the first vehicle.

16. A method of managing information, comprising:
receiving information about a driving feature of a vehicle from an in-vehicle device mounted on the vehicle;
configuring, on the basis of the information received, evaluation information indicating safety of the driving feature, the evaluation information being associated with an identifier of the vehicle;
registering the vehicle as credit information if the evaluation information associated with the identifier satisfies a criterion, the credit information recommending the vehicle as a superior vehicle;
transmitting the registered credit information to another user differing from the vehicle, so as to become available for the other user; and
selecting, on the basis of the credit information, the superior vehicle running within a predetermined distance from a user's current location, if, in the receiving, information indicating the user's current location and information indicating that the user desires to use a predetermined service with a vehicle are received from the user's mobile terminal,
wherein, in the transmitting, the selected superior vehicle is transmitted to the user's mobile terminal.

17. A method of managing information, comprising:
receiving information about a driving feature of a vehicle from an in-vehicle device mounted on the vehicle;
configuring, on the basis of the information received, evaluation information indicating safety of the driving feature, the evaluation information being associated with an identifier of a driver of the vehicle;
registering the driver as credit information if the evaluation information associated with the identifier satisfies a criterion, the credit information recommending the driver as a superior driver; and
transmitting the registered credit information to another user differing from the driver, so as to become available for the other user,
wherein, if information indicating that a shop provides to a customer a predetermined service with a vehicle is received from a terminal in the shop, information indicating whether the customer is registered as the superior driver is transmitted to the terminal in the shop on the basis of the credit information.
